(19) United States
(12) Patent Application Publication
(10) Pub. No.: US 2002/0171218 A1
(43) Pub. Date: Nov. 21, 2002

(54) Tie rod end support

(75) Inventor: Dale K. Bell, Ortonville, MI (US)

Correspondence Address: Kerrie A. Laba, CARLSON, GASKEY & OLDS, P.C., Suite 350, 400 W. Maple, Birmingham, MI, 48009, US

(73) Assignee: Meritor Heavy Vehicle Technology, LLC

(21) Appl. No.: 09/858,284

(22) Filed: May 15, 2001

(51) Int. Cl. B62D 7/18

(52) U.S. Cl. 280/93.512; 280/771

(57) ABSTRACT

A steering assembly interconnects right and left wheel ends on a vehicle. The steering assembly includes right and left steering knuckles that each support tie rod arms. One of the knuckles includes a steering arm that receives steering input from the vehicle's steering wheel. A tie rod assembly includes a cross-tube and a pair of tie rod end assemblies that connect the tie rod arms to the cross-tube. The tie rod assembly transmits the steering input force from the steering arm knuckle to the opposite knuckle. Ball studs are used to connect each of the tie rod ends to the respective tie rod arm. A support member is mounted to the tie rod arm or ball stud to prevent separation of the tie rod end from the respective ball stud as tie rod end components wear or fail. The support member includes a lower portion that extends underneath the tie rod end and an upper end that engages the tie rod arm or ball stud assemblies to prevent separation.

### BACKGROUND OF THE INVENTION

This invention relates to a tie rod end support that is used to prevent a tie rod end from separating from a tie rod arm ball stud, and which provides notification to the operator that service is required.

A steering assembly interconnects right and left wheel ends on a vehicle. The steering assembly includes right and left steering knuckles that each support tie rod arms. Typically, one of the knuckles includes a steering arm that receives steering input from the vehicle's steering wheel. A tie rod interconnects the right and left tie rod arms and transmits the steering input force from the steering arm knuckle to the opposite knuckle. The tie rod includes a pair of end sockets that are interconnected by a cross tube.

Ball studs are used to connect each tie rod end socket to the respective tie rod arm. Bearings provide a rotational interface between the ball studs and the tie rod end sockets to perform the desired steering maneuver. Each ball stud includes a spherical end that is supported by a bearing received in the end socket and a threaded end that receives a nut. In a typical heavy-duty truck, the ball studs are assembled with the spherical ends pointing down toward the ground and the threaded ends extending upwardly through the tie rod arms.

Abusive duty cycles and poor maintenance can cause bearings in the tie rod end sockets to wear. If sufficient wear takes place the tie rod end socket may separate (i.e., drop off) from the tie rod arm and ball stud resulting in the loss of steering at one wheel. Vehicle operators have indicated that it is difficult to determine whether tie rod components are wearing to undesirable levels. Tie rod separations have occurred with no warning to the operator.

The passenger car industry has addressed this issue by reversing the end configuration by installing the stud through the tie rod arm from the top. Heavy-duty truck packaging for suspension, engine, and other wheel components prevents this configuration from being a viable solution.

Thus, it is desirable to have a way to provide the operators with an indication of when the tie rod end is failing while maintaining steering capability at both wheels. The method and apparatus should be cost effective, easily incorporated into the tie rod steering assembly, and should provide failsafe design that allows operators to control the vehicle without a tie rod end component separation from the vehicle.

### SUMMARY OF THE INVENTION

A steering axle includes tie rod arms and tie rod end assemblies for each wheel. Each wheel includes a steering knuckle that supports one tie rod arm that is connected to one tie rod end assembly. One of the knuckles receives steering input from a vehicle operator. A tie rod extends between the tie rod end assemblies to transmit steering input forces from the steering input knuckle to the opposite knuckle on the axle via the tie rod arms. A support member is included with the tie rod end assembly or the tie rod arm to prevent the tie rod end from separating from the ball stud.

A tie rod end assembly includes bearings supported within a socket and a ball stud that connects the tie rod arm to the tie rod end. The bearings are installed within the tie rod end sockets to support the ball stud and to provide a rotational interface between the tie rod end and the ball studs. The support member prevents the tie rod end socket from separating from the ball stud as the bearing wears.

In the preferred embodiment, the support member is C-shaped with a lower base having a slot that extends underneath the tie rod end and an upper base having an opening for receiving a portion of the ball stud. A vertical wall interconnects the upper and lower bases and extends along one side of the tie rod arm and end socket.

The method for securing the tie rod to the tie rod arm includes the steps of attaching a tie rod arm to a tie rod end with a ball stud, and installing a support member to prevent the tie rod end from separating from the ball stud due to occurrence of component wear or failure. The preferred method includes extending one end of the support member underneath the tie rod end, engaging an opposite end of the support member to one of the tie rod arm or ball stud, and then threading a nut onto the ball stud to secure the ball stud to the tie rod arm. In one embodiment, the method includes folding the opposite end having an opening over the tie rod end assembly.

The subject method and apparatus provides a simple and effective way to prevent tie rod separation if a tie rod end component should fail. These and other features of the present invention can be best understood from the following specification and drawings, the following of which is a brief description.

### BRIEF DESCRIPTION OF THE DRAWINGS

FIG. 1 is front view of a tie rod steering assembly.

FIG. 2 is a partial cross-section of one tie rod end assembly incorporating the subject invention.

FIG. 3 is a perspective view of one embodiment of the subject invention.

FIG. 4 is a perspective view of an alternate embodiment of the subject invention.

FIG. 5 is a view similar to FIG. 2 including an alternate embodiment.

### DETAILED DESCRIPTION OF A PREFERRED EMBODIMENT

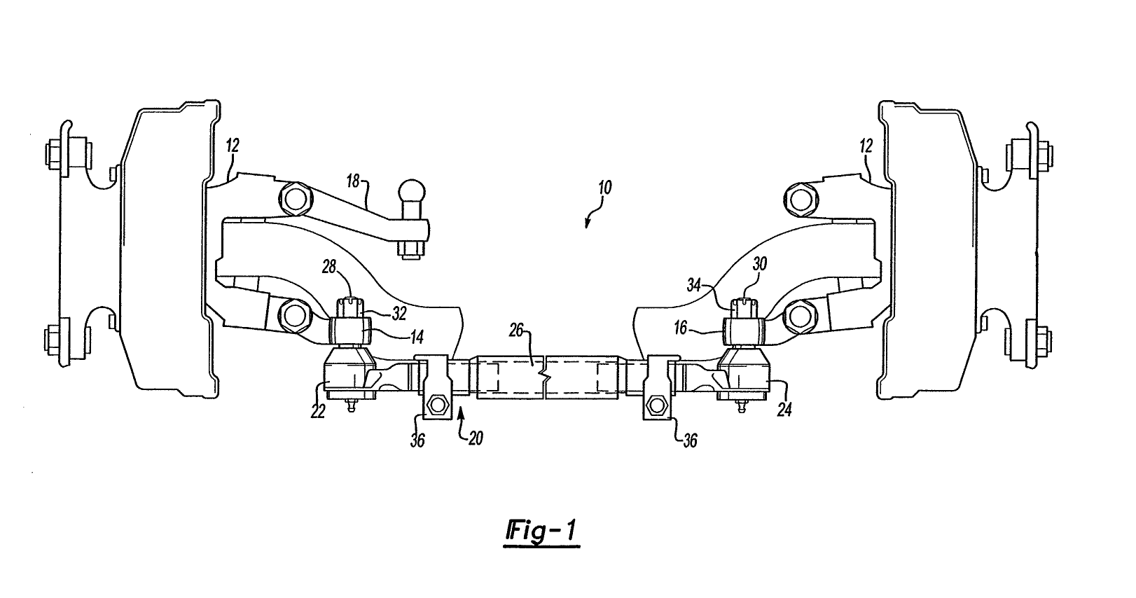

A tie rod steering assembly is shown generally at 10 in FIG. 1. The tie rod steering assembly 10 of FIG. 1 is typically used in a non-drive front steering axle (not shown) for a heavy-duty truck. The assembly 10 includes left and right hand steering knuckles 12. A first tie rod arm 14 is connected to one of the steering knuckles 12 and a second tie rod arm 16 is connected to the other steering knuckle 12. One of the steering knuckles 12 includes a steering arm 18 that receives steering input from vehicle operator (not shown).

A tie rod assembly 20 extends between the tie rod arms 14, 16 to transmit steering forces from the steering input knuckle 12 to the opposite knuckle 12. The tie rod assembly 20 includes a first tie rod end socket 22, a second tie rod end socket 24, and a cross-tube 26 that interconnects the first 22 and second 24 tie rod end sockets. A first ball stud 28 is received within the first tie rod end socket 22 to connect the first tie rod arm 14 to the tie rod 20. A second ball stud 30 is received within the second tie rod end socket 24 to connect the second tie rod arm 16 to the tie rod 20. A first nut 32 is threaded on the first ball stud 28 to secure the ball stud 28 to the first tie rod arm 14 and a second nut 34 is threaded on the second ball stud 30 to secure the ball stud 30 to the second tie rod arm 16. Clamps 36 are used to secure the first 22 and second 24 tie rod end sockets to the cross-tube 26.

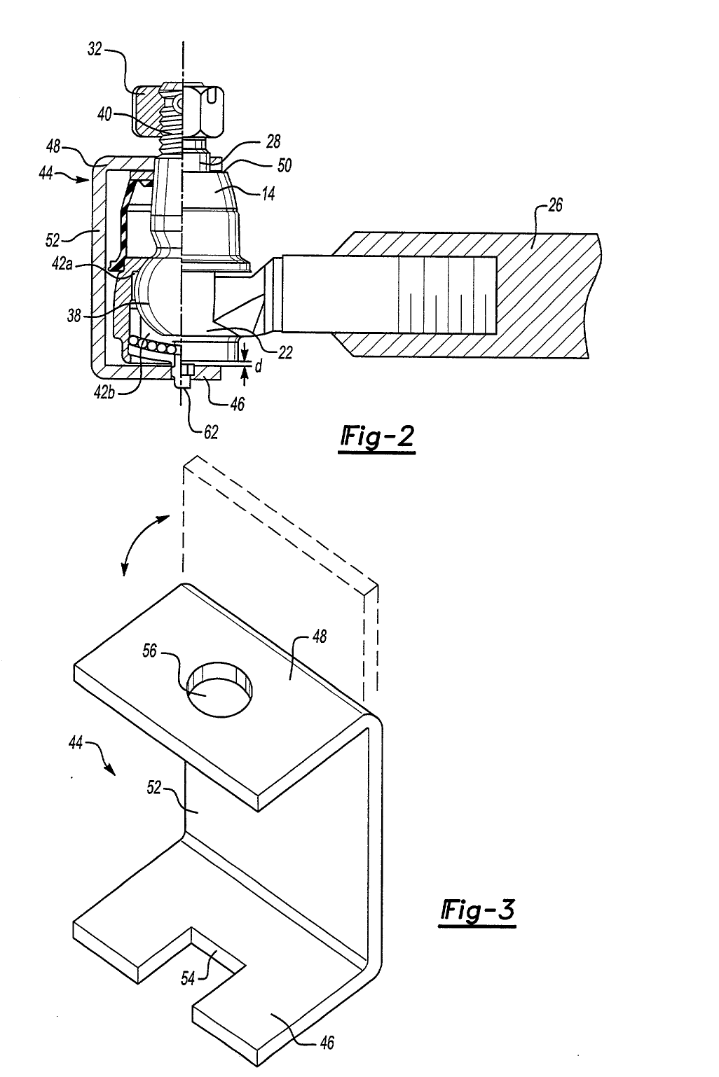

The first ball stud 28 and tie rod end assembly are shown in greater detail in FIG. 2. It should be understood that all descriptions regarding the first ball stud 28 also cover the second ball stud 30 and that the left hand and right tie rod end assemblies are similar in construction. The ball stud 28 includes a spherical end 38 and a threaded end 40 that extends upwardly from the tie rod arm 14. A bearing assembly 42 is received within the tie rod end socket 22. The spherical end 38 of the ball stud 28 is rotatingly mounted within the bearing assembly 42 to provide relative rotation between the ball stud 28 and the tie rod socket 22 such that the desired steering maneuver can be transmitted from the steering input knuckle 12 to the opposing knuckle 12. A similar bearing is positioned in the second tie rod end socket 24 to support the second ball stud 30. The bearing assembly 42 preferably includes an upper bearing 42a and a lower bearing 42b.

As the upper bearing 42a wears, the fit between the ball stud 28 and tie rod end socket 22 can loosen. If the bearing 42a wears too much, the tie rod end socket 22 can drop away from the ball stud 28 resulting in tie rod separation and loss of steering at one wheel. A support member 44 is installed within the tie rod end assembly to prevent this separation from occurring.

In one embodiment, the support member 44 has a lower portion 46 that is extends underneath the tie rod end socket 22, and which has an upper portion 48 that partially engages an upper surface 50 of the tie rod arm 14 or which engages the ball stud 28. A vertical side portion 52 interconnects the lower 46 and upper 48 portions. When the upper bearing 42a has worn sufficiently such that it no longer retains the spherical end 38 of the ball stud 28 in place, the end socket 22 will drop away from the ball stud 28. As the socket 22 drops, it will hit the lower portion 46 of the support member 44 to keep the spherical end 38 within the socket 22.

The support member 44 can be attached to the tie rod end socket 22 and the ball stud and/or tie rod arm 14 by any of the various attachment methods known in the art. The preferred attachment method is tack welding.

The lower portion 46 is preferably spaced by a distance “d” below the lower surface of the tie rod end socket 22. Preferably, “d” is a distance of 3/16 inches, which is an amount that provides notification to the operator that service is required, however, other distances can also be used.

A preferred embodiment of a C-shaped support member 44 is shown in FIG. 1. The lower portion 46 includes an open-ended slot 54 that is received around a portion of the tie rod end socket 22, namely a grease fitting 62. The upper portion 48 includes a circular aperture 56 that is received over an upper end of the ball stud 28. Preferably the upper portion 48 is initially extended upwardly, as indicated in dashed lines, to permit assembly of the support member 44 over the stud end when inserted into the tie rod arm 14 and then folded down along line “A” over the socket end 22 to complete the assembly.

An alternate embodiment of a support member 144 is shown in FIG. 4. The lower portion 146 is similar to that of the FIG. 3 embodiment but the upper portion 148 includes an open-ended slot 158 that is received around the ball stud 28. The upper portion 148 can be attached to either the tie rod arm 14 or ball stud 28.

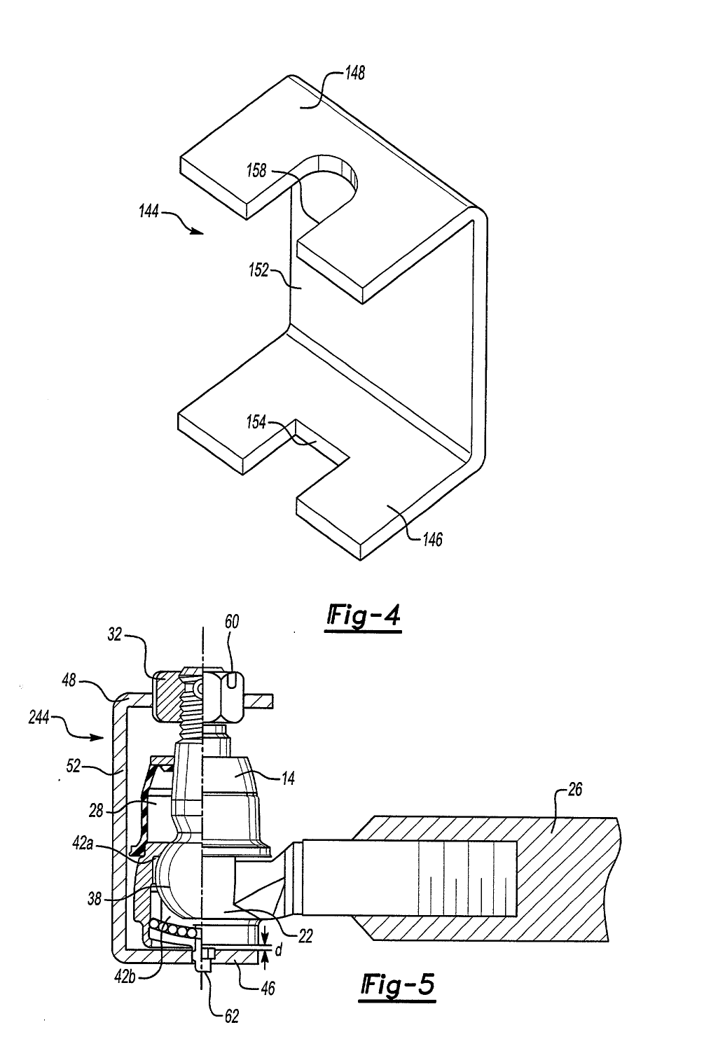

Another alternate embodiment is shown in FIG. 5. A support member 244 includes a lower portion 246 that extends underneath the tie rod end socket 22 and an upper portion 248 that is attached to an exterior portion 60 of the nut 32. A vertical wall portion 252 extends along the side of the tie rod arm 14 and the nut 32. Preferably the upper portion 248 is tack welded to the nut 32.

The subject method and apparatus provides a simple and cost effective way to prevent the tie rod 20 from separating from the tie rod arms 14, 16 when the bearing 42 wears or fails.

Although a preferred embodiment of this invention has been disclosed, it should be understood that a worker of ordinary skill in the art would recognize many modifications come within the scope of this invention. For that reason, the following claims should be studied to determine the true scope and content of this invention.

What is claimed is:

1. A tie rod assembly comprising:
a tie rod arm supported by an axle member;
a tie rod end for connecting said tie rod arm to a tie rod that extends laterally from said tie rod arm toward a second axle member to transmit steering forces between said first and second axle members;
a ball stud for connecting said tie rod arm to said tie rod end; and
a support member attached to one of said tie rod arm or said ball stud to prevent said tie rod end from separating from said ball stud.

2. An assembly according to claim 1 including a bearing mounted between said ball stud and said tie rod end to permit relative rotation between said ball stud and said tie rod end and wherein said support member prevents said tie rod end from separating from said ball stud as said bearing wears.

3. An assembly according to claim 2 wherein said ball stud includes a spherical end supported by said bearing and said tie rod end includes a socket for supporting said bearing.

4. An assembly according to claim 2 wherein said support member includes a lower end extending under said tie rod end and an upper end attached to said tie rod arm.

5. An assembly according to claim 2 wherein said support member includes a lower end extending under said tie rod end and an upper end attached to said ball stud.

6. An assembly according to claim 2 including a nut threaded to one end of said ball stud to retain said ball stud to said tie rod arm wherein said support member includes an upper end that is attached to said nut.

7. An assembly according to claim 2 wherein said support member is C-shaped with a lower base member having a slot, a top base member having an opening, and a vertically extending wall interconnecting said lower and top base members.

8. An assembly according to claim 7 wherein a portion of said tie rod end is at least partially received within said slot.

9. An assembly according to claim 8 wherein said opening is a slot that receives a portion of said ball stud located at a vertically higher position over said tie rod arm relative to said tie rod.

10. An assembly according to claim 8 wherein said opening is a circular hole that surrounds said ball stud above said tie rod arm.

11. A steering assembly comprising:
a first tie rod arm supported by a first axle member;
a second tie rod arm supported by a second axle member positioned laterally opposite from said first axle member;
a tie rod interconnecting said first and second tie rod arms to transmit steering forces between said first and second axle members;
a first ball stud for connecting said first tie rod arm to one end of said tie rod;
a first bearing supporting said first ball stud to provide relative rotation between said first ball stud and said one end of said tie rod;
a second ball stud for connecting said second tie rod arm to an opposite end of said tie rod;
a second bearing supporting said second ball stud to provide relative rotation between said second ball stud and said opposite end of said tie rod;
a first support member for preventing said tie rod from separating from said first ball stud as said first bearing wears; and
a second support member for preventing said tie rod from separating from said second ball stud as said second bearing wears.

12. An assembly according to claim 11 wherein said first and second support members each include a first end extending under said tie rod and a second end for engaging one of said respective tie rod arm or ball stud.

13. An assembly according to claim 11 wherein said first and second ball studs each include a spherical end received within said respective bearing and a threaded end that extends upwardly beyond said respective tie rod arm to receive a nut.

14. An assembly according to claim 13 wherein said first and second support members each include a first end extending under said tie rod and a second end for engaging said respective nut.

15. An assembly according to claim 11 wherein each of said support members includes a lower base member having a slot for receiving at least a portion of said tie rod, a top base member having an opening for receiving at least a portion of said respective ball stud, and a vertically extending wall interconnecting said lower and top base members.

16. A method for securing a tie rod to a tie rod arm comprising the steps of:
(a) attaching a tie rod arm to a tie rod end with a ball stud; and
(b) installing a support member to prevent the tie rod end from separating from the ball stud due to occurrence of component wear or failure.

17. A method according to claim 16 wherein step (b) includes extending the support member from a position underneath the tie rod end to a vertical position above the tie rod arm.

18. A method according to claim 16 wherein step (b) includes positioning a lower end of the support member to at least partially extend underneath the tie rod end and positioning an upper end of the support member to at least partially surround an upper end of the ball stud.

19. A method according to claim 18 wherein positioning the upper end of the support member includes folding a portion of the support member downwardly to surround a portion of the ball stud and subsequently tightening a nut onto the ball stud to secure the tie rod arm to the tie rod.
